(19) United States
(12) Patent Application Publication
(10) Pub. No.: US 2013/0236234 A1
(43) Pub. Date: Sep. 12, 2013

(54) DUAL TUBE FRANGIBLE JOINT

(71) Applicant: Geoffrey Paul Kaczynski, Westlake Village, CA (US)

(72) Inventor: Geoffrey Paul Kaczynski, Westlake Village, CA (US)

(73) Assignee: ENSIGN-BICKFORD AEROSPACE & DEFENSE COMPANY, Simsbury, CT (US)

(21) Appl. No.: 13/442,399

(22) Filed: Apr. 9, 2012

Related U.S. Application Data
(60) Provisional application No. 61/607,129, filed on Mar. 6, 2012.

(51) Int. Cl. B64G 1/64; C06C 5/00

(52) U.S. Cl. 403/2; 102/275.1

(57) ABSTRACT

A frangible joint for separating a pair of components is provided. The frangible joint includes a first portion coupled one of the pair of components and a second portion coupled to the other of the pair of components. The first portion and the second portion are spaced apart by a gap. At least one plate is coupled between the first portion and the second portion across the gap. A first tube having a first explosive cord is disposed therein and a first pliable member arranged between the first explosive cord and the first tube, the first tube being disposed in the gap. A second tube having a second explosive cord is disposed therein and a second pliable member arranged between the second explosive cord and the second tube, the second tube being disposed in the gap adjacent the first tube.

### BACKGROUND OF THE INVENTION

The present invention relates in general to frangible joint separation systems also known to as expanding tube separation, and in particular, to a dual tube frangible joint used to explosively separate two components in a reliable manner.

It is known to utilize linear explosive frangible joints to explosively separate two components, such as that of a missile, satellite or other type of space or air travel vehicle during flight or operation (e.g., to separate two vehicle stages or to separate a payload from a launch vehicle). For example, it is known to utilize a single, elongated, flexible continuous explosive cord that comprises, e.g., a mild detonating fuse (“MDF”) that explodes upon detonation. The explosive cord may be encased in a silicone rubber or other pliable material that is surrounded by a stainless steel tube. This arrangement may be applied to a portion or all of the periphery or circumference of a joint, connection point or location between two components that are desired to be explosively separated at that location at a predetermined time. The explosive cord is typically initiated at one or more ends of the cord and the cord causing the cord to explosively detonate along its length to separate the components.

However, this arrangement may suffer from the drawback that sometimes the single, explosive cord fails to detonate as desired, thereby creating a risk that the two components may not separate as desired, potentially causing loss of vehicle or mission.

It is also known to utilize a dual, redundant explosive cord design that typically comprises two explosive cords, each surrounded by, e.g., a silicone rubber material, and housed together in the same tube without any separation device between the two cords encased within the rubber material. That is, the rubber material surrounding the two explosive cords is contiguous in the space between and around the two explosive cords. In operation, one of the two cords is ignited and explosively detonates, thereby properly separating the two components. In the event that the first ignited cord does not properly explosively detonates and thus fails to separate the two components, the other cord may be ignited in an attempt to explosively detonate the two components.

However, this arrangement can suffer from drawbacks such as cross propagation between the two explosive cords when one of the cords is ignited. Other drawbacks include undesired sympathetic detonation of both explosive cords, secondary fracture of the structure, and duding failure modes.

What is needed is a frangible joint that comprises a dual, redundant explosive cord design including two explosive cords, each disposed in its own tube, that has a first one of the explosive cords detonate to properly explosively separate the two components without inadvertently explosively detonating the second one of the explosive cords, and in the event that the first explosive cord does not properly explosively detonate then a second one of the explosive cords can be explosively detonated to properly separate the two components.

### SUMMARY OF THE INVENTION

According to an embodiment of the present invention, a frangible joint is provided. The frangible joint includes a first portion and a second portion. The first portion and second portion are spaced apart to define a gap. A first explosive cord is arranged within the gap adjacent the first portion. A first pliable member is disposed about the first explosive cord. A first sheath is disposed about the first pliable member. A second explosive cord is arranged within the gap and positioned between the first sheath and the second portion. A second pliable member is disposed about the second explosive cord. A second sheath is disposed about the second pliable member.

According to another embodiment of the present invention, a frangible joint for separating a pair of components is provided. The frangible joint includes a first portion coupled one of the pair of components. A second portion is coupled to the other of the pair of components, the first portion and the second portion being spaced apart with a gap therebetween. At least one plate is coupled between the first portion and the second portion across the gap. A first tube has a first explosive cord disposed therein and a first pliable member arranged between the first explosive cord and the first tube, the first tube being disposed in the gap. A second tube has a second explosive cord disposed therein and a second pliable member arranged between the second explosive cord and the second tube, the second tube being disposed in the gap adjacent the first tube.

According to another embodiment of the invention, a method of separating a first component from a second component with a frangible joint is provided. The method includes providing a first tube having a first explosive cord disposed therein and a first pliable member arranged between the first explosive cord and the first tube. A second tube is provided having a second explosive cord disposed therein and a second pliable member arranged between the second explosive cord and the first tube. The first explosive cord is detonated. A predetermined amount of time is waited. The second explosive cord is detonated when the first explosive cord does not explode.

### BRIEF DESCRIPTION OF THE DRAWINGS

The various embodiments of the present invention can be understood with reference to the following drawings. The components are not necessarily to scale. Also, in the drawings, like reference numerals designate corresponding parts throughout the several views.

FIG. 1 is a perspective view of a portion of a frangible joint in accordance with an embodiment of the invention;

FIG. 2 is a sectional view of the frangible joint in accordance with another embodiment of the invention; and,

FIG. 3 is a sectional view of the frangible joint in accordance with another embodiment of the invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of” Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases. In at least some instances, the approximating language may correspond to the precision of an instrument for measuring the value.

In an embodiment of the present invention, a frangible joint includes dual tubes, each tube having an explosive cord located therein in a redundant design, the tubes optionally being separated by a spacer, wherein a first one of the explosive cords explosively detonates to properly separate the two components without inadvertently explosively detonating the second one of the explosive cords, and in the event that the first explosive cord does not properly explosively detonate then a second one of the explosive cords is explosively detonated to properly separate the two components.

The foregoing and other features of various disclosed embodiments of the invention will be more readily apparent from the following detailed description and drawings of the illustrative embodiments of the invention wherein like reference numbers refer to similar elements.

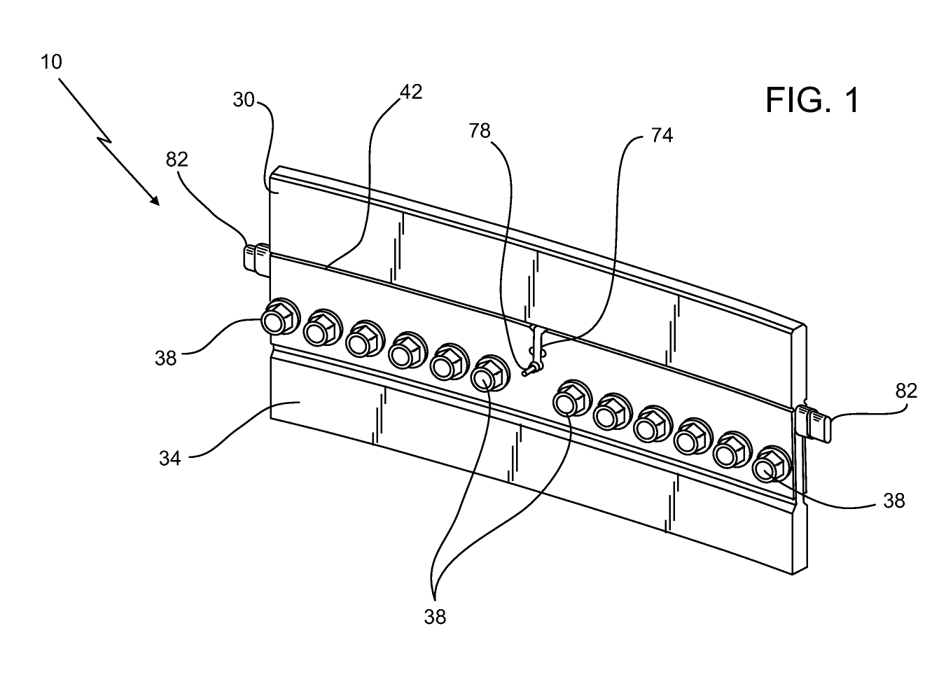

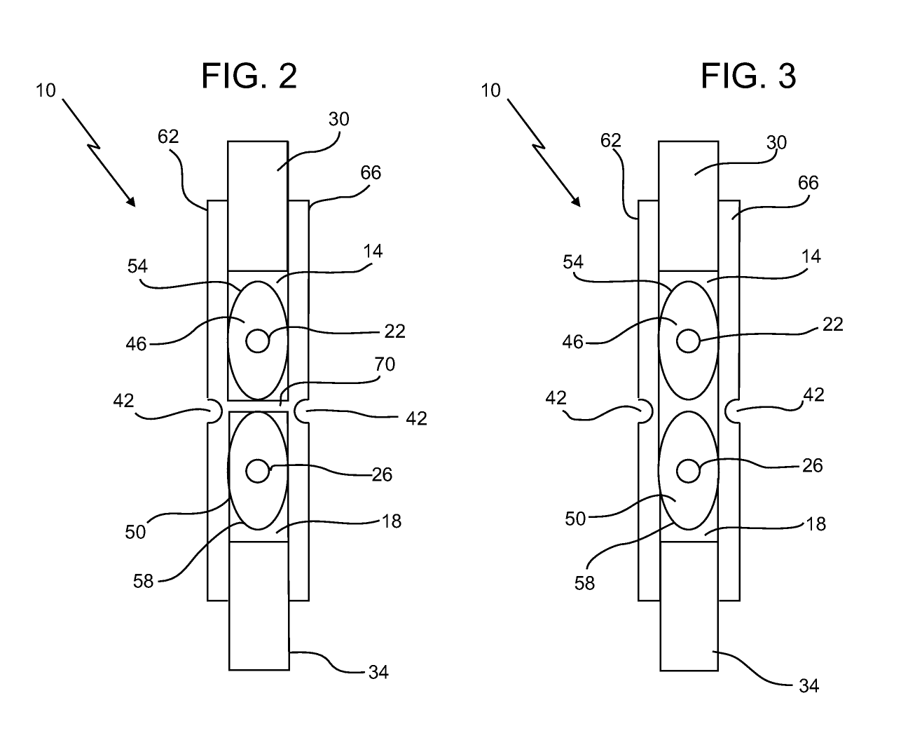

Referring to FIGS. 1, 2, and 3 there illustrated is a portion of a frangible joint 10 that includes a pair of tubes, or “dual tubes”, 14, 18, each tube 14, 18 having an explosive cord 22, 26 located therein in a redundant design according to an embodiment of the present invention and located at a desired separation point between two components (not shown) desired to be explosively separated at a certain point in time. The two components may comprise those of a missile, satellite or other type of space or air travel vehicle to be separated during flight or operation (e.g., two vehicle stages, or a payload and a launch vehicle), but may also be applied to any application where a separation event is required. A first one of the components to be separated may connect with a first, upper portion 30 (as viewed in Figures) of the frangible joint 10, while a second one of the components to be separated may connect with a second, lower portion 34 (as viewed in FIGS. 1 and 2) of the frangible joint 10. Typically, the first component and corresponding upper portion 30 of the frangible joint 10 continues on in flight after the explosive detonation occurs, while the second component and corresponding lower portion 34 of the frangible joint 10 falls away after the explosive detonation occurs. It should be appreciated that while embodiments herein describe the frangible joint 10 or its components using the relative terms “upper” and “lower”, this is for exemplary purposes and the frangible joint described herein may be used in any orientation.

The two portions 30, 34 of the frangible joint 10 may, in an embodiment, comprise separate pieces that are connected together by a plurality of, e.g., bolts and nuts 38. One or more separation notches or grooves 42 may be provided along a length of the upper portion 30 of the frangible joint 10. The notches or grooves 42 provide for a relatively weakened section of the upper portion 30 such that when one of the explosive cords 22, 26 is explosively detonated, the upper portion 30 of the frangible joint 10 (as viewed in FIGS. 1 and 2) continues on in flight and everything below the upper portion 30 (as viewed in FIGS. 1 and 2) falls away.

FIG. 2 illustrates one embodiment of the dual tube frangible joint 10 according to an embodiment of the invention in which each of the explosive cords 22, 26 is surrounded by an oval-shaped piece of rubber, elastomeric or other pliable material 46, 50. The pliable material helps to reduce the amount of shock from the explosive detonation of an explosive cord 22, 26 that may affect the other, non-detonated cord 22, 26. Also, each piece of pliable material 46, 50 is surrounded by a piece of stainless steel 54, 58, thereby forming a sheath around the piece of pliable material 46, 50. Each resulting oval-shaped arrangement of the explosive cord 22, 26, piece of pliable material 46, 50 and steel sheath 54, 58 is located within a corresponding one of the dual tubes 14, 18. Each tube 14, 18, in the embodiment of FIG. 2, is bounded by a pair of opposing plates 62, 66, the respective upper and lower portions 30, 34 of the frangible joint 10, and a spacer 70 located between the tubes 14, 18. The spacer 70 may be formed integral with one or both of the structure of the tubes 14, 18, or, in another embodiment, the spacer 70 may comprise a separate piece of material. Also, in yet another embodiment, the space may be omitted as shown in FIG. 3. The plates 62, 66, the upper and lower portions 30, 34, and the spacer 70 may all comprise aluminum, or other suitable materials and may be suitable connected together. Also, one or more notches or grooves 42 may be formed in the plates 62, 66.

Although not shown in FIG. 2, FIG. 1 illustrates that the lower arrangement of the explosive cord 26, the piece of rubber 50, and the steel sheath 58 may be further surrounded by a steel strap 74 that attaches to the plate 62 by a nut and bolt arrangement 76. This arrangement ensures that when the upper explosive cord 22 is explosively detonated (which is typically the case as opposed to the lower cord 26 being explosively detonated firstly), the lower explosive cord 26 remains with the lower portion 34 of the frangible joint 10 when it falls away after successful explosive detonation. However, by providing a pair of explosive cords 22, 26, if the upper cord 22 fails to properly explode when explosively detonated, the lower cord 26 may then be explosively detonated to cause the separation of the frangible joint 10.

FIG. 1 illustrates another embodiment in which a unitary tube 82 is utilized to hold the two explosive cords 22, 26 instead of the separate plates 62, 66 as in the embodiment of FIG. 2. The spacer 70 may also be utilized in the embodiment of FIG. 1 so as to properly separate the explosive cords 22, 26. In the embodiments of FIG. 2, the spacer 70 may comprise other than a piece of aluminum. For example, the spacer 70 may comprise a retainer clip for each arrangement of explosive cords 22, 26, rubber material 46, 50, and steel sheaths 54, 58. The spacer 70 or retainer clips may be used to properly separate each arrangement of explosive cords 22, 26, pliable material 46, 50, and steel sheaths 54, 58 so that the possibility of cross propagation between the two explosive cords 22, 26 is significantly reduced or even eliminated. Also, the spacer 70 or retainer clips reduce or eliminate the possibility of sympathetic detonation and duding failure modes.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A frangible joint comprising:
a first portion;
a second portion, the first portion and the second portion being spaced apart to define a gap;
a first explosive cord within the gap adjacent the first portion;
a first pliable member disposed about the first explosive cord;
a first sheath disposed about the first pliable member;
a second explosive cord within the gap and positioned between the first sheath and the second portion;
a second pliable member disposed about the second explosive cord; and,
a second sheath disposed about the second pliable member.

2. The frangible joint of claim 1 further comprising a spacer member arranged between the first sheath and the second sheath.

3. The frangible joint of claim 1 further comprising a tube member positioned in the gap, wherein the first sheath and the second sheath are arranged within the tube member.

4. The frangible joint of claim 3 further comprising a spacer member arranged between the first sheath and the second sheath.

5. The frangible joint of claim 1 further comprising first plate coupled between a first side of the first portion and the second portion, and a second plate coupled between a second side of the first portion and the second portion.

6. The frangible joint of claim 5 wherein the first plate and the second plate each include a groove.

7. The frangible joint of claim 5 further comprising a strap member coupled between the first plate and the second sheath.

8. The frangible joint of claim 1 wherein the first pliable member and the second pliable member are each made from rubber.

9. A frangible joint for separating a pair of components, the frangible joint comprising:
a first portion coupled one of the pair of components;
a second portion coupled to the other of the pair of components, the first portion and the second portion being spaced apart with a gap therebetween;
at least one plate coupled between the first portion and the second portion across the gap;
a first tube having a first explosive cord disposed therein and a first pliable member arranged between the first explosive cord and the first tube, the first tube being disposed in the gap; and,
a second tube having a second explosive cord disposed therein and a second pliable member arranged between the second explosive cord and the second tube, the second tube being disposed in the gap adjacent the first tube.

10. The frangible joint of claim 9 wherein the first pliable member and the second pliable member are made from rubber.

11. The frangible joint of claim 9 wherein the first tube and the second tube are made from stainless steel.

12. The frangible joint of claim 9 further comprising a spacer disposed between the first tube and the second tube.

13. The frangible joint of claim 12 wherein the spacer is integral with the first tube.

14. The frangible joint of claim 12 wherein the spacer is transverse to the at least one plate across the gap.

15. The frangible joint of claim 9 further comprising a third tube disposed within the gap, wherein the first tube and the second tube are disposed within the third tube.

16. A method of separating a first component from a second component with a frangible joint, the method comprising:
providing a first tube having a first explosive cord disposed therein and a first pliable member arranged between the first explosive cord and the first tube;
providing a second tube having a second explosive cord disposed therein and a second pliable member arranged between the second explosive cord and the first tube;
detonating the first explosive cord;
waiting a predetermined amount of time; and,
detonating the second explosive cord when the first explosive cord does not explode.

17. The method of claim 16 further comprising arranging a spacer between the first tube and the second tube.

18. The method of claim 16 further comprising providing a third tube and disposing the first tube and the second tube in the third tube.

19. The method of claim 16 further comprising providing at least one plate and coupling the second tube to the at least one plate with a strap.

20. The method of claim 16 wherein the first pliable member and the second pliable member are made from rubber.
